(19) United States
(12) Patent Application Publication
(10) Pub. No.: US 2025/0076494 A1
(43) Pub. Date: Mar. 6, 2025

(54) PROXIMITY ULTRASONIC SENSING APPARATUS AND PROXIMITY ULTRASONIC SENSING SYSTEM USING THE SAME

(71) Applicant: SonicMEMS (ZhengZhou) Technology Co.,Ltd., Zhengzhou (CN)

(72) Inventors: Yi-Hsiang Chiu, Zhengzhou (CN); Rei Jinchi, Zhengzhou (CN); Hsien-Tsong Chen, Zhengzhou (CN)

(21) Appl. No.: 18/390,455

(22) Filed: Dec. 20, 2023

(30) Foreign Application Priority Data
Aug. 29, 2023 (TW) 112132650

(51) Int. Cl. G01S 15/04; G01S 7/521

(52) U.S. Cl. CPC G01S 15/04; G01S 7/521

(57) ABSTRACT

A proximity ultrasonic sensing apparatus includes a microprocessor and an ultrasonic sensing assembly. The microprocessor generates a control signal. The ultrasonic sensing assembly includes a boost circuit to boost the control signal into a driving signal, an ultrasonic transmitting module to generates and sends an ultrasonic signal according to the driving signal, an ultrasonic receiving module to converts reflection of the ultrasonic signal into a reflection signal, and an amplifying circuit to amplifies the reflection signal into a sensing signal. A transmitting/receiving angle of the ultrasonic transmitting module and the ultrasonic receiving module is in a range of 2 to 10 degrees. The microprocessor generates a sensing result according to the sensing signal. A frequency of the ultrasonic signal is in a range of 500 KHz to 1.2 MHz. A sensing distance of the ultrasonic sensing assembly is in a range of 0.2 to 8 centimeters.

### CROSS-REFERENCE TO RELATED APPLICATION

This non-provisional application claims priority under 35 U.S.C. § 119 (a) to patent application No. 112132650 filed in Taiwan, R.O.C. on Aug. 29, 2023, the entire contents of which are hereby incorporated by reference.

### BACKGROUND

### Technical Field

The present invention relates to the field of circuit board sensing, and in particular, to a proximity ultrasonic sensing apparatus and a proximity ultrasonic sensing system using the same.

### Related Art

There are many ways to detect objects, such as using light passage/blocking, reflection/absorption, magnetic induction, and the like, to achieve identification or recognition. In terms of optical recognition, a traditional barcode and a QR code mainly use an optical scanner to illuminate the barcode with its own light source, then use a photoelectric converter to receive reflected light, and convert lightness and darkness of the reflected light into a digital signal.

However, for a narrow space or an object whose material is highly reflective and highly penetrative, the use of the barcode is relatively limited.

In terms of magnetic induction, near-field communication, such as radio frequency identification (RFID), is used for sensing, and has a wider application range. However, compared with the traditional barcode, the RFID requires an antennas and a chip, and the overall cost is relatively high.

### SUMMARY

In order to solve the problem faced by the prior art, a proximity ultrasonic sensing apparatus is provided. The proximity ultrasonic sensing apparatus includes a microprocessor and an ultrasonic sensing assembly. The microprocessor generates and sends a control signal, and the ultrasonic sensing assembly includes a boost circuit, an ultrasonic transmitting module, an ultrasonic receiving module, and an amplifying circuit. The boost circuit is electrically connected to the microprocessor, receives the control signal, and boots the control signal into a driving signal. The ultrasonic transmitting module is electrically connected to the boost circuit, receives the driving signal, and generates an ultrasonic signal and sends the ultrasonic signal out. A transmitting angle of the ultrasonic transmitting module is in a range of 2 to 10 degrees. The ultrasonic receiving module receives an ultrasonic reflection signal generated through reflection of the ultrasonic signal, converts the ultrasonic reflection signal into a reflection signal, and sends the reflection signal, where a receiving angle of the ultrasonic receiving module is in a range of 2 to 10 degrees. The amplifying circuit is electrically connected to the ultrasonic receiving module and the microprocessor, receives the reflection signal, amplifies the reflection signal into a sensing signal, and then transmits the sensing signal to the microprocessor. The microprocessor generates a sensing result according to the sensing signal. A frequency of the ultrasonic signal and the ultrasonic reflection signal is in a range of 500 KHz to 1.2 MHz. A sensing distance of the ultrasonic sensing assembly is in a range of 0.2 to 8 centimeters.

In some embodiments, the ultrasonic transmitting module, the ultrasonic receiving module, the boost circuit, and the amplifying circuit are packaged in a same chip.

In some embodiments, the ultrasonic transmitting module and the ultrasonic receiving module include at least one piezoelectric micromachined ultrasonic transducer (PMUT).

Preferably, in some embodiments, the ultrasonic transmitting module and the ultrasonic receiving module respectively include a plurality of piezoelectric micromachined ultrasonic transducers, and the piezoelectric micromachined ultrasonic transducers are arranged in an array.

In some embodiments, the frequency of the ultrasonic signal and the ultrasonic reflection signal is in a range of 600 KHz to 800 MHZ, the transmitting angle and the receiving angle are in a range of 3 to 5 degrees, and the sensing distance of the ultrasonic sensing assembly is in a range of 0.3 to 3 centimeters.

In addition, a proximity ultrasonic sensing system is further provided. The proximity ultrasonic sensing system includes a proximity ultrasonic sensing apparatus, a to-be-sensed object, a database, and a central processing unit. The proximity ultrasonic sensing apparatus includes a microprocessor and an ultrasonic sensing assembly. The microprocessor generates and sends a control signal, and the ultrasonic sensing assembly includes a boost circuit, an ultrasonic transmitting module, an ultrasonic receiving module, and an amplifying circuit. The boost circuit is electrically connected to the microprocessor, receives the control signal, and boots the control signal into a driving signal. The ultrasonic transmitting module is electrically connected to the boost circuit, receives the driving signal, and generates an ultrasonic signal and sends the ultrasonic signal out. A transmitting angle of the ultrasonic transmitting module is in a range of 2 to 10 degrees. The ultrasonic receiving module receives an ultrasonic reflection signal generated through reflection of the ultrasonic signal, converts the ultrasonic reflection signal into a reflection signal, and sends the reflection signal, where a receiving angle of the ultrasonic receiving module is in a range of 2 to 10 degrees. The amplifying circuit is electrically connected to the ultrasonic receiving module and the microprocessor, receives the reflection signal, amplifies the reflection signal into a sensing signal, and then transmits the sensing signal to the microprocessor. The microprocessor generates a sensing result according to the sensing signal. A frequency of the ultrasonic signal and the ultrasonic reflection signal is in a range of 500 KHz to 1.2 MHz.

The to-be-sensed object includes a sensing label, where the sensing label includes a wave attenuation portion and a wave reflection portion, when the ultrasonic signal is reflected by the sensing label, the ultrasonic reflection signal is generated, where a sensing distance between the proximity ultrasonic sensing apparatus and the to-be-sensed object is in a range of 0.2 to 8 centimeters. The central processing unit enables the microprocessor to generate the control signal according to an operation instruction, and accesses data in the database to perform a comparison according to the sensing result of the proximity ultrasonic sensing apparatus.

In some embodiments, the ultrasonic transmitting module and the ultrasonic receiving module include at least one piezoelectric micromachined ultrasonic transducer (PMUT).

Preferably, in some embodiments, the ultrasonic transmitting module and the ultrasonic receiving module respectively include a plurality of piezoelectric micromachined ultrasonic transducers, and the piezoelectric micromachined ultrasonic transducers are arranged in an array.

In some embodiments, the frequency of the ultrasonic signal and the ultrasonic reflection signal is in a range of 600 KHz to 800 MHZ, the transmitting angle and the receiving angle are in a range of 3 to 5 degrees, and the sensing distance of the ultrasonic sensing assembly is in a range of 0.3 to 3 centimeters.

In some embodiments, the wave attenuation portion of a sensing portion is a wave attenuating coating, a wave scattering coating, or a wave absorbing material.

As shown in the foregoing embodiments, by setting the frequency of the ultrasonic signal and the ultrasonic reflection signal, the transmitting angle, and the receiving angle within a specific range, the ultrasonic sensing assembly may have a high directivity and is suitable to be applied and operate in an environment at a close distance, with insufficient light, or with light penetration, which can reduce situations that cannot be traditionally sensed.

### BRIEF DESCRIPTION OF THE DRAWINGS

FIG. 1 is a block diagram of a proximity ultrasonic sensing apparatus.

FIG. 2 is a block diagram of a proximity ultrasonic sensing system.

FIG. 3 is a schematic diagram of a sensing label.

FIG. 4 to FIG. 6 are schematic diagrams of different application embodiments of a proximity ultrasonic sensing system.

### DETAILED DESCRIPTION

It should be understood that when an element is referred to as being “arranged” on another element, it may indicate that the element is directly on the another element, or there may also be an intermediate element, and the element is connected to the another element through the intermediate element. On the contrary, when an element is referred to as being “directly arranged on another element” or “directly arranged to another element”, it may be understood that, in this case, it is clearly defined that there is no intermediate element.

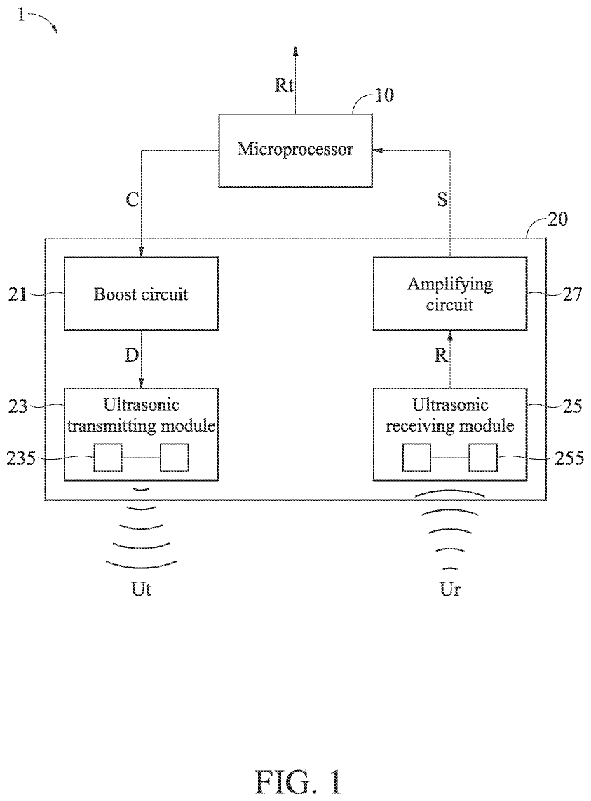

FIG. 1 is a block diagram of a proximity ultrasonic sensing apparatus. As shown in FIG. 1, a proximity ultrasonic sensing apparatus 1 includes a microprocessor 10 and an ultrasonic sensing assembly 20. The microprocessor 10 generates and sends a control signal C, and the ultrasonic sensing assembly 20 includes a boost circuit 21, an ultrasonic transmitting module 23, an ultrasonic receiving module 25, and an amplifying circuit 27. The boost circuit 21 is electrically connected to the microprocessor 10, receives the control signal C, and boots the control signal C into a driving signal D. The ultrasonic transmitting module 23 is electrically connected to the boost circuit 21, receives the driving signal D, and generates an ultrasonic signal Ut and sends the ultrasonic signal Ut out. A transmitting angle of the ultrasonic transmitting module 23 is in a range of 2 to 10 degrees. The ultrasonic receiving module 25 receives an ultrasonic reflection signal Ur generated through reflection of the ultrasonic signal Ut, converts the ultrasonic reflection signal Ur into a reflection signal R, and sends the reflection signal R, where a receiving angle of the ultrasonic receiving module 25 is in a range of 2 to 10 degrees. This case mainly converts the ultrasonic reflection signal Ur into an electrical signal. The amplifying circuit 27 is electrically connected to the ultrasonic receiving module 25 and the microprocessor 10, receives the reflection signal R, amplifies the reflection signal R into a sensing signal S, and then transmits the sensing signal S to the microprocessor 10. The microprocessor 10 generates a sensing result Rt according to the sensing signal S.

A frequency of the ultrasonic signal Ut and the ultrasonic reflection signal Ur is in a range of 500 KHz to 1.2 MHz. A sensing distance of the ultrasonic sensing assembly 20 is in a range of 0.2 to 8 centimeters. Preferably, in some embodiments, the frequency of the ultrasonic signal Ut and the ultrasonic reflection signal Ur is in a range of 600 KHz to 800 MHZ, the transmitting angle and the receiving angle are in a range of 3 to 5 degrees, and the sensing distance of the ultrasonic sensing assembly 20 is in a range of 0.3 to 3 centimeters.

In the existing technology, in addition to fingerprint sensing, an ultrasonic sensing apparatus is also used in vehicle distance sensing. However, a distance between 1 and 5 centimeters is usually considered to be a blind region of the ultrasonic sensing apparatus. However, proximity sensing may be performed effectively by limiting the frequency of an ultrasonic wave to a range of 600 KHz to 800 MHZ, and limiting the transmitting angle and the receiving angle to a range of 3 to 5 degrees.

In some embodiments, the ultrasonic transmitting module 23, the ultrasonic receiving module 25, the boost circuit 21, and the amplifying circuit 27 are packaged on a same chip. However, this is only an example of miniaturization and not a limitation. For example, the ultrasonic transmitting module 23 and the boost circuit 21 may also be packaged in a chip, and the ultrasonic receiving module 25 and the amplifying circuit 27 may be packaged in another chip.

Refer to FIG. 1 again. In some embodiments, the ultrasonic transmitting module 23 and the ultrasonic receiving module 25 may include at least piezoelectric micromachined ultrasonic transducers 235 and 255. Although an example in which there are two piezoelectric micromachined ultrasonic transducers 235 and 255, and the piezoelectric micromachined ultrasonic transducers 235 and 255 are arranged in an array are used, an actual quantity or configuration may be adjusted according to actual requirements of a product.

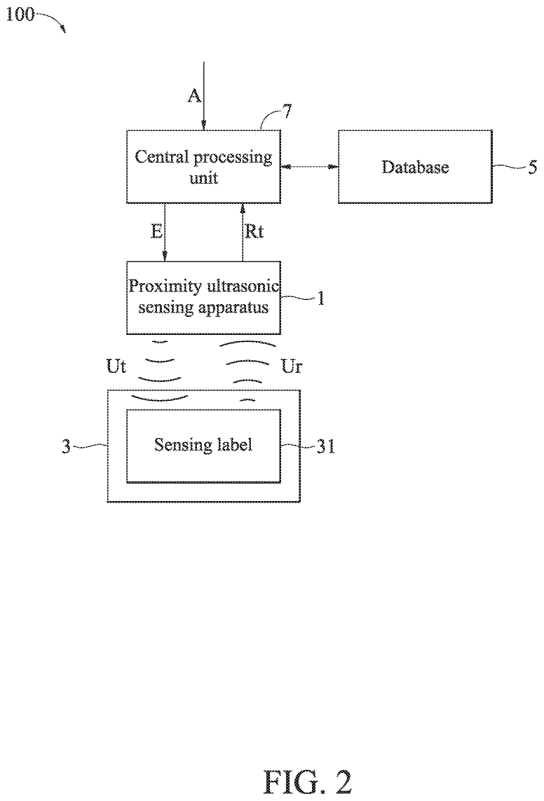

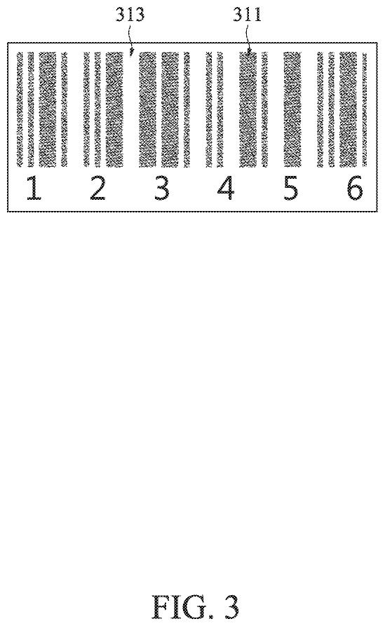

FIG. 2 is a block diagram of a proximity ultrasonic sensing system. As shown in FIG. 2, a proximity ultrasonic sensing system 100 is further provided. The proximity ultrasonic sensing system 100 includes a proximity ultrasonic sensing apparatus 1, a to-be-sensed object 3, a database 5, and a central processing unit 7. For a detailed structure of the proximity ultrasonic sensing apparatus 1, reference may be made to FIG. 1, and details are not described herein again. The central processing unit 7 sends an enable signal E according to an operation instruction A to enable the microprocessor 10 to generate a control signal C. The to-be-sensed object 3 includes a sensing label 31. The sensing label 31 includes a wave attenuation portion 311 and a wave reflection portion 313 (referring to FIG. 3). When the ultrasonic signal Ut transmitted by the ultrasonic transmitting module 23 is reflected by the sensing label 31, the ultrasonic reflection signal Ur is generated. The ultrasonic receiving module 25 translates the reflection intensity into a digital reflection signal, wherein the ultrasonic reflection signal Ur has different reflection intensities blocks according to the the wave attenuation portion 311 and the wave reflection 313.

The central processing unit 7 accesses data in the database 5 to perform a comparison according to the sensing result Rt of the proximity ultrasonic sensing apparatus 1, thereby recognizing the to-be-sensed object 3, or executing a corresponding operation instruction according to parsing of the to-be-sensed object 3. A sensing distance between the proximity ultrasonic sensing apparatus 1 and the to-be-sensed object 3 is in a range of 0.2 to 8 centimeters.

FIG. 3 is a schematic diagram of a sensing label. In FIG. 3, a common barcode (barcode) is used as the sensing label 31, but this is only an example and not a limitation. In fact, the sensing label may also be presented in a form of a QR code. As shown in FIG. 3, the barcode-type sensing label 31 is printed with a wave attenuation portion 311 and a wave reflection portion 313. The purpose of the wave attenuation portion 311 is to make the intensity of the ultrasonic reflection signal Ur corresponding to this region significantly attenuated. Wave-absorbing materials, such as cloth, wool, sponge, wave attenuating coatings, or reflection materials, may be used to reduce the intensity when the ultrasonic signal Ut comes into contact, or reflect it to an angle that exceeds an angle at which the ultrasonic receiving module 25 can receive. A suitable material may be selected cooperating with the to-be-sensed object 3, and a material of the sensing label 31 may be selected.

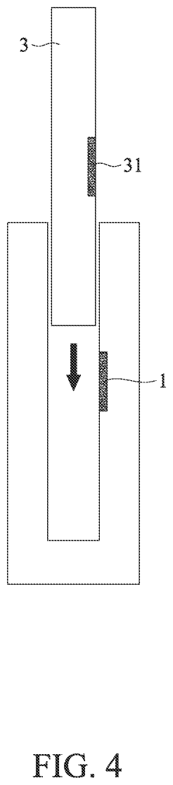

FIG. 4 to FIG. 6 are schematic diagrams of different application embodiments of a proximity ultrasonic sensing system. The following will introduce application of a proximity ultrasonic sensing system 100 by using different implementations. As shown in FIG. 4, the proximity ultrasonic sensing system 100 may be used in a door card over-current system of a hotel. The to-be-sensed object 3 is a room card. A traditional over-current system is to block light through the room card and then conduct the over-current through induction. For the sake of convenience, many travelers may plug in IDs and credit cards of the travelers to maintain power after going out, which not only leads to a waste of energy in the hotel, but also actually leads to the loss of many IDs. Therefore, the sensing label 31 may be arranged on the room card, and is designed on a corresponding side. Over-current is performed after the sensing label 31 is sensed and recognized as the room card.

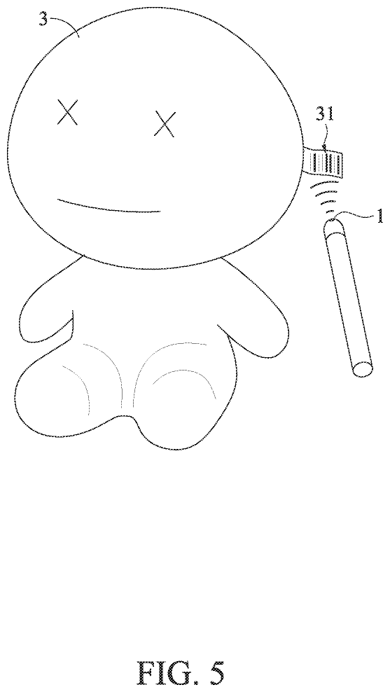

FIG. 5 may be sensing in a store. The proximity ultrasonic sensing apparatus 1 may be mounted on a sensing pen, and the sensing label 31 may be mounted on objects in the store, such as stuffed toys. The sensing label 31 may have different categories according to objects, and may be used for transparent or light-absorbing objects.

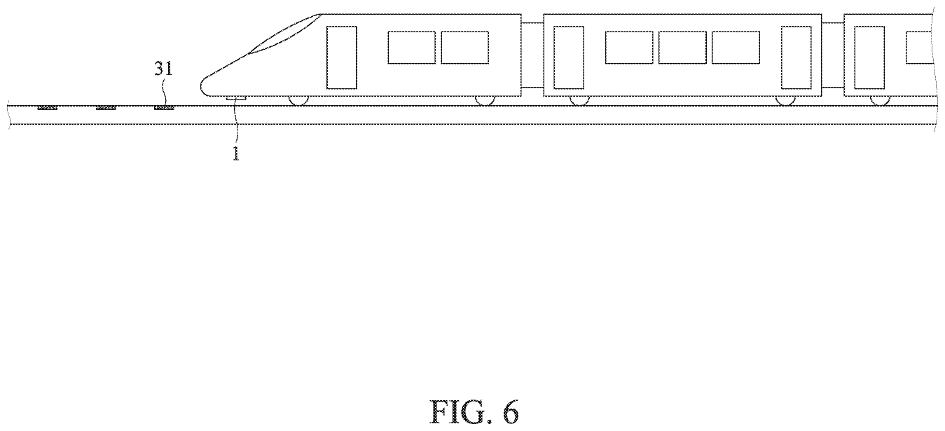

FIG. 6 may be applied to toys or the catering industry, for example, a rotating plate of conveyor belt sushi. The proximity ultrasonic sensing apparatus 1 may be mounted at a bottom portion of a dynamic toy, and the sensing label 31 may be transparent. After the proximity ultrasonic sensing apparatus 1 reads the sensing label 31, changes in light, color, or sound are generated according to a corresponding instruction on the sensing label 31.

In conclusion, by setting the frequency of the ultrasonic signal Ut and the ultrasonic reflection signal, the transmitting angle, and the receiving angle Ur within a specific range, the proximity ultrasonic sensing apparatus 1 may have a high directivity and is suitable to be applied and operate in an environment at a close distance, with insufficient light, or with light penetration, which can reduce situation that cannot be traditionally sensed.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A proximity ultrasonic sensing apparatus, comprising:
a microprocessor generating and sending a control signal; and
an ultrasonic sensing assembly comprising:
a boost circuit electrically connected to the microprocessor, receiving the control signal, and boosting the control signal into a driving signal;
an ultrasonic transmitting module electrically connected to the boost circuit, receiving the driving signal, and generating an ultrasonic signal and sending the ultrasonic signal out, wherein a transmitting angle of the ultrasonic transmitting module is in a range of 2 to 10 degrees;
an ultrasonic receiving module receiving an ultrasonic reflection signal generated through reflection of the ultrasonic signal, converting the ultrasonic reflection signal into a reflection signal, and sending the reflection signal, wherein a receiving angle of the ultrasonic receiving module is in a range of 2 to 10 degrees; and
an amplifying circuit electrically connected to the ultrasonic receiving module and the microprocessor, receiving the reflection signal, amplifying the reflection signal into a sensing signal, and then transmitting the sensing signal to the microprocessor, wherein the microprocessor generates a sensing result according to the sensing signal, wherein
a frequency of the ultrasonic signal and the ultrasonic reflection signal is in a range of 500 KHz to 1.2 MHz, and a sensing distance of the ultrasonic sensing assembly is in a range of 0.2 to 8 centimeters.

2. The proximity ultrasonic sensing apparatus according to claim 1, wherein the ultrasonic transmitting module, the ultrasonic receiving module, the boost circuit, and the amplifying circuit are packaged in a same chip.

3. The proximity ultrasonic sensing apparatus according to claim 2, wherein the ultrasonic transmitting module and the ultrasonic receiving module comprise at least one piezoelectric micromachined ultrasonic transducer.

4. The proximity ultrasonic sensing apparatus according to claim 3, wherein the ultrasonic transmitting module and the ultrasonic receiving module respectively comprise a plurality of piezoelectric micromachined ultrasonic transducers, and the piezoelectric micromachined ultrasonic transducers are arranged in an array.

5. The proximity ultrasonic sensing apparatus according to claim 1, wherein a frequency of the ultrasonic signal and the ultrasonic reflection signal is in a range of 600 KHz to 800 MHZ, the transmitting angle and the receiving angle are in a range of 3 to 5 degrees, and the sensing distance of the ultrasonic sensing assembly is in a range of 0.3 to 3 centimeters.

6. A proximity ultrasonic sensing system, comprising:
a proximity ultrasonic sensing apparatus, comprising a microprocessor and an ultrasonic sensing assembly, wherein the microprocessor generates and sends a control signal, and the ultrasonic sensing assembly comprises a boost circuit, an ultrasonic transmitting module, an ultrasonic receiving module, and an amplifying circuit, wherein the boost circuit is electrically connected to the microprocessor, receives the control signal, and boots the control signal into a driving signal; the ultrasonic transmitting module is electrically connected to the boost circuit, receives the driving signal, and generates an ultrasonic signal and sends the ultrasonic signal out, wherein a transmitting angle of the ultrasonic transmitting module is in a range of 2 to 10 degrees; the ultrasonic receiving module receives an ultrasonic reflection signal generated through reflection of the ultrasonic signal, converts the ultrasonic reflection signal into a reflection signal, and sends the reflection signal, wherein a receiving angle of the ultrasonic receiving module is in a range of 2 to 10 degrees; and the amplifying circuit is electrically connected to the ultrasonic receiving module and the microprocessor, receives the reflection signal, amplifies the reflection signal into a sensing signal, and then transmits the sensing signal to the microprocessor, and the microprocessor generates a sensing result according to the sensing signal, wherein a frequency of the ultrasonic signal and the ultrasonic reflection signal is in a range of 500 KHz to 1.2 MHz;
a to-be-sensed object, comprising a sensing label, wherein the sensing label comprises a wave attenuation portion and a wave reflection portion, when the ultrasonic signal is reflected by the sensing label, the ultrasonic reflection signal is generated, wherein a sensing distance between the proximity ultrasonic sensing apparatus and the to-be-sensed object is in a range of 0.2 to 8 centimeters;
a database; and
a central processing unit, enabling the microprocessor to generate the control signal according to an operation instruction, and accessing data in the database to perform a comparison according to the sensing result of the proximity ultrasonic sensing apparatus.

7. The proximity ultrasonic sensing system according to claim 6, wherein the ultrasonic transmitting module and the ultrasonic receiving module comprise at least one piezoelectric micromachined ultrasonic transducer.

8. The proximity ultrasonic sensing system according to claim 7, wherein the ultrasonic transmitting module and the ultrasonic receiving module respectively comprise a plurality of piezoelectric micromachined ultrasonic transducers, and the piezoelectric micromachined ultrasonic transducers are arranged in an array.

9. The proximity ultrasonic sensing system according to claim 6, wherein the frequency of the ultrasonic signal and the ultrasonic reflection signal is in a range of 600 KHz to 800 MHZ, the transmitting angle and the receiving angle are in a range of 3 to 5 degrees, and the sensing distance of the ultrasonic sensing assembly is in a range of 0.3 to 3 centimeters.

10. The proximity ultrasonic sensing system according to claim 6, wherein the wave attenuation portion of the label is a wave attenuating coating, a wave scattering coating, or a wave absorbing material.
